(19) United States
(12) Patent Application Publication
(10) Pub. No.: US 2005/0170057 A1
(43) Pub. Date: Aug. 4, 2005

(54) Marshmallow, beverage topped with marshmallows, and frozen dessert with marshmallows

(75) Inventors: Masakazu Kuhara, Saga-shi (JP); Toshiaki Takeshita, Saga-shi (JP); Masatake Egashira, Saga-shi (JP)

Correspondence Address: WOOD, PHILLIPS, KATZ, CLARK & MORTIMER, 500 W. MADISON STREET, SUITE 3800, CHICAGO, IL, 60661, US

(73) Assignee: Takeshita Seika Kabushiki kaisha

(21) Appl. No.: 11/045,925

(22) Filed: Jan. 28, 2005

(30) Foreign Application Priority Data
Feb. 4, 2004 (JP) 27948/2004

(51) Int. Cl. A23J 3/00

(52) U.S. Cl. 426/571

(57) ABSTRACT

High water-soluble marshmallows having solubility so as to be dissolved to form a creamy layer while topping a beverage and adapted to be drunk or eaten in a creamy or liquefied state on the beverage. Each marshmallow has a water activity of 0.70 or more, being of a disk shape that has a substantially circular periphery in a plan view and has curved outlines at the periphery in a vertical section. The marshmallows are dissolved on the surface of hot coffee to form a uniform layer in thickness and provide creamy marshmallow coffee. The marshmallows have a pleasant texture and taste good when they are mixed with an ice cream.

### TECHNICAL FIELD

The present invention relates to a marshmallow, and more particularly to a high water-soluble marshmallow having solubility so as to be dissolved to form a creamy layer while topping a beverage and adapted to be drunk or eaten in a creamy or liquefied state on the beverage. The present invention also relates to a beverage topped with the marshmallows. The present invention further relates to a frozen dessert formed by mixing the marshmallows with a frozen dessert matrix.

### BACKGROUND ART

A marshmallow is one of occidental confections known from a long time ago. A marshmallow is a spongy confection made of gelatin in major proportions, sugar, corn starch, a flavoring, and the like, which are mixed, beaten, formed, and solidified. It is the most common way to eat marshmallows alone plainly, whereas a way to eat marshmallows in combination with other foods has been proposed. For example, so-called “marshmallow coffee”, which is hot coffee topped with marshmallows, has been proposed and it has been already served to consumers in some shops. The marshmallow coffee is mild to the taste so as to be very similar to Viennese coffee with whipped cream and its demand is expected as a new way to eat marshmallows. As to the conventional art relating to the marshmallow coffee, a beverage containing a solid beverage such as instant coffee and marshmallows is, for example, disclosed in JP 7-303452A.

However, the marshmallow coffee using the marshmallows in the above-described conventional art is coffee with a few marshmallows, which can be hardly dissolved in the coffee, only floating thereon. Most of the marshmallows in the conventional art are, as shown in FIG. 4A, of a short cylindrical shape each having both a diameter and a height of a few centimeters, so that its size and shape may result in preventing the marshmallows from being dissolved. However, even if the marshmallows are put into coffee after being broken into small pieces, solid masses of uneven size are generated on the way of dissolving and prevented from being fully dissolved. Consequently, the reason why it is difficult for the marshmallow in the conventional art to be dissolved is probably due to the nature of the marshmallow in itself. The JP 7-303452A described above discloses an example using marshmallows cut into 5 mm dice, though it mentions neither its composition nor its solubility. Provision of a marshmallow having high solubility in a beverage such as coffee can provide creamy drink such as marshmallow coffee that is more pleasant to the taste with easier preparation.

Further, a frozen dessert formed by mixing marshmallows with a frozen dessert matrix such as an ice cream has been already proposed. However, the marshmallows that are mixed in the frozen dessert matrix often become hardened due to low temperature, so marshmallows that will not reduce their pleasant texture when they are mixed in a frozen dessert matrix have been desired.

It is therefore an object of the present invention to provide improved high water-soluble marshmallows having solubility so as to be dissolved to form a creamy layer while topping a beverage and adapted to be drunk or eaten in a creamy or liquefied state on the beverage, and marshmallows that will not reduce their pleasant texture when they are mixed in a frozen dessert matrix.

### SUMMARY OF THE INVENTION

Careful studies by inventors of the present invention to solve the problems described above brought about a conclusion that a water activity of a marshmallow is an important parameter for solubility. More specifically, the inventors found that a marshmallow having a higher water activity than the marshmallow in the conventional art have higher solubility. Further, the inventors have established a means of manufacturing marshmallows each having a water activity adapted for dissolution, and succeeded to provide high water-soluble marshmallows. Further, the marshmallows are found to keep their pleasant texture and taste good even they are mixed in a frozen dessert matrix. The summary of the invention is as follows.

One of aspects of the present invention is to provide a marshmallow having a water activity of 0.70 or more.

The marshmallow in the aspect has a higher water activity than that of a conventional marshmallow. More specifically, a conventional marshmallow has a water activity of 0.67 or less, resulting in a low solubility. On the other hand, the marshmallow in the aspect has a water activity of 0.70 or more, so as to have extremely a high solubility. The marshmallow in the aspect, while topping a beverage such as coffee, absorbs the beverage and is readily dissolved in the absorbed beverage, as if it melts, thereby being adapted to be drunk or eaten in a liquefied state on the beverage.

It is preferable that the marshmallow has a water activity of 0.75 or less.

The marshmallow in the preferred aspect not only achieves a high solubility, but also prevents noxious organism such as mold from propagating thereon thanks to a water activity of 0.75 or less. Consequently, the marshmallow in the aspect has good preservation, so as to have an advantage when being distributed.

Another aspect of the present invention is to provide a marshmallow formed by pouring a liquid containing at least either of sugar and gelatin and having a density in a range of 400 to 440 g/L into a mold by a filler and solidifying the liquid.

The marshmallow in the aspect has a density in a range of 400 to 440 g/L before solidification, thereby obtaining after solidification a water activity suitable for easy dissolution. Further, in the aspect, using the filler to pour the liquid material in the mold brings about no difficulty in pouring even with such high water content as having a density in a range of 400 to 440 g/L, so that it is easy to form them.

Still further, the aspect inevitably leads to a marshmallow having a high water activity and a high solubility. Therefore, the marshmallow is readily dissolved while topping a beverage such as coffee, thereby being adapted to be drunk or eaten in a liquefied state on the beverage.

It is preferable that the marshmallow has a water activity of 0.70 or more.

The marshmallow in the preferred aspect has extremely a high solubility. The marshmallow is readily dissolved while topping a beverage such as coffee, thereby being adapted to be drunk or eaten in a liquefied state on the beverage.

It is preferable that the marshmallow is of a disk shape that has a substantially circular periphery in a plan view and has curved outlines at the periphery in a vertical section.

It is preferable that the marshmallow is of a disk shape that has a substantially circular periphery in a plan view and is tapered to decrease its thickness toward its periphery.

It is preferable that the marshmallow is of a disk shape having a central part thickness larger than a thickness at its peripheral part.

Each marshmallow in the preferred aspects is of a disk shape having a substantially circular periphery and different from the conventional marshmallow. Further, each of the marshmallows has such a unique shape that has curved outlines at the periphery, is tapered to decrease its thickness toward its periphery, and has a central part thickness larger than a thickness at its peripheral part. Therefore, in the case of topping the surface of the beverage with the marshmallows, the marshmallows overlap each other at moderate areas, without gap therebetween, and on the other hand, without too thickly overlapping partially. Consequently, the marshmallows coat the surface of a beverage such as coffee uniformly in thickness. As a result, the marshmallows dissolved on the surface of a beverage such as coffee form a uniform layer in thickness, thereby providing smooth marshmallow coffee and the like.

Herein, the periphery of the disk denotes an outer periphery in a plan view of the disk, and indicates the same meaning as a peripheral edge. The peripheral part denotes an area including the periphery.

It is preferable that the marshmallow has a diameter and a central part thickness with a ratio of the diameter to the central part thickness in a range of 1.0 to 5.0.

The marshmallows in the preferred aspect overlap at moderate areas without gap therebetween more certainly when overlapping with the other marshmallows. As a result, the marshmallows dissolved on the surface of a beverage such as coffee form a uniform layer in thickness more certainly.

It is preferable that the marshmallow has a diameter in a range of 10 to 20 mm.

It is preferable that the marshmallow has a central part thickness in a range of 4 to 10 mm.

The marshmallows in the preferred aspects have a size such that the marshmallows overlap each other at moderate areas when coffee in a coffee cup, for example, is topped with several or more than ten marshmallows. More specifically, too large diameters of the marshmallows are apt to cause gap therebetween upon topping the surface of coffee with the marshmallows. Too large thicknesses of the central parts of the marshmallows make them difficult to overlap each other, also being apt to cause gap therebetween. On the other hand, when the diameters or the thicknesses of the central parts are too small, a creamy layer formed by dissolution are so thin as to be disappeared immediately with bubbles. On the contrary, the marshmallows in the aspects have a size such that they overlap each other more certainly, thereby leading to coat the surface of coffee more uniformly in thickness when the surface is topped with them. As a result, several or more than ten marshmallows dissolved on the surface of coffee form a uniform layer in thickness, so that coffee topped with marshmallows that is smooth to the taste is provided. The layer of the dissolved marshmallows keeps moderate thickness, so as to be protected from immediately disappearing. Further, a continuous layer formed by a plurality of dissolved marshmallows is so beautiful aesthetically as to stimulate one's appetite. Still further, the marshmallows in the aspects spread over the entire surface of coffee without thickness variation due to the shape and size thereof when coffee is topped with a plurality of marshmallows.

Still another aspect of the invention is to provide a marshmallow having a water activity in a range of 0.70 to 0.75 and being of a disk shape that has a substantially circular periphery in a plan view, curved outlines at the periphery in a vertical section, a diameter in a range of 10 to 20 mm, a central part thickness in a range of 4 to 10 mm, and a ratio of the diameter to the central part thickness in a range of 1.0 to 5.0.

The marshmallow in the aspect has extremely a high solubility, and is readily dissolved on a beverage such as coffee, so as to be adapted to be drunk or eaten in a liquefied state on the beverage. Further, the marshmallows coat the surface of coffee more uniformly in thickness upon topping the coffee therewith. Still further, when coffee is topped with a plurality of marshmallows, the marshmallows spread over the entire surface of coffee without thickness variation due to the shape and size thereof.

It is preferable that the marshmallow is formed by pouring a liquid containing at least either of sugar and gelatin and having a density in a range of 400 to 440 g/L into a mold by a filler and solidifying the liquid.

The marshmallow in the preferred aspect has a density in a range of 400 to 440 g/L before solidification, thereby obtaining after solidification a water activity suitable for easy dissolution. Further, in the aspect, using the filler to pour the liquid material in the mold brings about no difficulty in pouring even with such high water content as having a density in a range of 400 to 440 g/L, so that it is easy to form them.

Still further, the aspect inevitably leads to the marshmallow having a high water activity and a high solubility. Therefore, the marshmallow is readily dissolved on the beverage such as coffee, so as to be drunk or eaten in a liquefied state on the beverage.

Yet another aspect of the invention is to provide a beverage topped with marshmallows having a water activity of 0.70 or more and dissolved while topping the surface of the beverage that has a temperature of 40 degrees centigrade or more.

Yet still another aspect of the invention is to provide a beverage topped with marshmallows formed by pouring a liquid containing at least either of sugar and gelatin and having a density in a range of 400 to 440 g/L into a mold by a filler and solidifying the liquid, and dissolved while topping the surface of the beverage that has a temperature of 40 degrees centigrade or more.

In the beverages in the aspects, the marshmallows are dissolved on the surface of the beverage to form a uniform layer in thickness. As a result, the beverage is smooth to the taste in comparison with a beverage with the marshmallows in the conventional art dissolved while topping the beverage.

It is preferable that the beverage is one selected from a group consisting of coffee, cocoa, powdered green tea (Matcha), black tea, Japanese tea, oolong tea, and milk.

In the beverage in the preferred aspect, the marshmallows are dissolved on the surface of the beverage such as coffee to form a uniform layer in thickness. As a result, the beverage is smooth to the taste in comparison with a beverage with the marshmallows in the conventional art dissolved while topping the beverage.

Another aspect of the invention is to provide a frozen dessert formed by mixing marshmallows having a water activity of 0.70 or more with a frozen dessert matrix.

Still another aspect of the invention is to provide a frozen dessert formed by mixing marshmallows with a frozen dessert matrix, the marshmallows being formed by pouring a liquid containing at least either of sugar and gelatin and having a density in a range of 400 to 440 g/L into a mold by a filler and solidifying the liquid.

The frozen desserts in the aspects bring about a pleasant texture of the marshmallows.

It is preferable that the frozen dessert matrix is an ice cream.

In the frozen dessert in the preferred aspect, the marshmallows do not get hard and maintain a pleasant texture. The marshmallows taste good even if they are eaten with an ice cream.

It is preferable that the ice cream has an overrun in a range of 40 to 200%.

In the frozen dessert in the preferred aspect, the marshmallows have an extremely pleasant texture and taste good even if they are eaten with an ice cream.

### BRIEF DESCRIPTION OF THE DRAWINGS

FIGS. 1A, 1B, 1C, and 1D show a marshmallow in a preferred embodiment of the present invention, FIG. 1A being a plan view, FIG. 1B being a front view, FIG. 1C being a cross-sectional view taken along line A-A of FIG. 1A, FIG. 1D being a cross-sectional view taken along line B-B of FIG. 1B;

FIGS. 2A, 2B, and 2C illustrate states of the marshmallows in the embodiment of the invention dissolved on coffee, FIG. 2A being a partly broken cross-sectional view showing a state of the marshmallows topping the surface of the coffee, FIG. 2B being a perspective view showing a state of the marshmallows topping the surface of the coffee, FIG. 2C being a cross-sectional view showing a state of the marshmallows dissolved on the coffee;

FIG. 3 is a cross-sectional view showing an ice cream with marshmallows in the embodiment of the invention.

FIGS. 4A, 4B, and 4C illustrate a type of conventional marshmallows and states of the marshmallows being dissolved on coffee, FIG. 4A being a perspective view of the conventional marshmallow, FIG. 4B being a perspective view of a state of the conventional marshmallows topping the surface of the coffee, FIG. 4C being a cross-sectional view of a state of the conventional marshmallows being dissolved on the coffee;

FIGS. 5A, 5B, and 5C show another type of conventional marshmallows and states of the marshmallows being dissolved on coffee, FIG. 5A being a perspective view of the conventional marshmallow, FIG. 5B being a perspective view of a state of the conventional marshmallows topping the surface of the coffee, FIG. 5C being a cross-sectional view of a state of the conventional marshmallows being dissolved on the coffee.

### DESCRIPTION OF THE PREFERRED EMBODIMENTS

In the present invention, a marshmallow is defined as a spongy confection made of gelatin, sugar, corn starch, a flavoring, and the like, which are mixed, beaten, formed, and solidified. Further, the marshmallow in the invention includes its equivalent. An equivalent of a marshmallow is one having the ingredients of a marshmallow as defined above, except that some ingredient is added, eliminated, substituted or the like and being capable of equated with a marshmallow.

Sugars used for the marshmallow in the invention may be sugars in the known art including sugar such as glucose, maltose, lactose, and sucrose, sugar alcohol such as sorbitol, and starch syrup (in Japanese, “Mizuame”) saccharized by reduction or enzyme. It is possible to use only one kind or two kinds or more of these sugars. Concentration of the sugars contained in the marshmallow is about 40 to 80% by weight, and preferably about 70 to 80% by weight.

Gelatin used for the marshmallow in the invention may be accordingly selected among food that are commonly-served, regardless of its origin. Concentration of the gelatin contained in the marshmallow is about 1 to 10% by weight, and preferably about 2.5 to 3.5% by weight. Herein, albumen may be used instead of all or a part of the gelatin. Further, flavoring, artificial color, or the like as well as the sugars and the gelatin described above may be appropriately added to the marshmallow in the invention.

Forming methods of a marshmallow generally include an extruder method by which dough is continuously extruded from a nozzle to be cut and formed, and a depositor method by which dough is deposited on a mold by a filler so that the dough is formed thereon, the latter method being especially preferable in the case of the marshmallow in the invention. The former method is not fit to be used for the marshmallow in the invention, resulting from its higher water activity than ever before and its soft dough.

The marshmallow is manufactured as follows, for example. First, syrup is prepared by dissolving sugars, which are ingredients, in water with heating in a heating kneader. Then, the syrup is transferred into a blender in which the syrup is slowly stirred while being kept hot. A temperature of the blender may be 60 to 70 degrees centigrade and preferably 65 degrees centigrade and a stirring speed may be, for example, 15 rpm. In the meantime, gelatin solution is prepared by dissolving gelatin in water with heating. The gelatin solution is transferred into the blender and mixed with the syrup so as to prepare a mixed solution of the gelatin and the sugar. At the time of the mixing, it is preferable to raise the temperature in the blender to the extent of 80 degrees centigrade, and increase the stirring speed to the extent of 45 rpm. The mixed solution is continued to be blended enough while air is supplied in the blender, so that the mixed solution is aerated. An amount of aerated air is freely controlled depending on a quantity of air supply at that time. The mixed solution is aerated while a density of the mixed solution is measured, and when the density reaches 400 to 440 g/L and preferably 420 g/L, flavoring is added. When the temperature in the blender is lowered to the extent of 53 degrees centigrade, the mixed solution is transferred into a filler.

The mixed solution of the gelatin and the sugars transferred into the filler is poured into, for example, a mold arranged on a corn starch. The marshmallow in the invention is completed by solidifying the mixed solution by letting the solution stand at cool room temperature. Herein, the corn starch remains on the surface of the marshmallow to be used as a powder for taking it easily.

The marshmallow in the invention is dissolved in water at a temperature of 40 degrees centigrade or more. Consequently, any beverage to be topped with dissolved marshmallow layer must be at a temperature of 40 degrees centigrade or more. Beverages to be topped with the marshmallows include coffee, cocoa, powdered green tea (Matcha), black tea, Japanese tea, oolong tea, milk and the like, though coffee is typical. A temperature of the beverage may be selected among suitable temperatures depending on the kind of beverages. Coffee may be at about a temperature of 80 degrees centigrade, and cocoa may be at a temperature of 70 degrees centigrade, for example.

The marshmallows are dissolved by themselves upon topping hot coffee, so a creamy layer covers the coffee. At this time, it is not necessary to stir with a spoon or the like. In this way, the present invention can provide a creamy marshmallow coffee being equivalent of Viennese coffee with whipped cream. Cocoa powder or the like may further be sprinkled on the dissolved marshmallows. The marshmallows in the invention have a high elasticity and a high moisture content, so as to have a pleasant taste even if they are eaten as single item.

The marshmallows in the invention have a pleasant texture and taste good even if they are mixed with a frozen dessert matrix. Especially, even if they are mixed with a frozen dessert matrix at a temperature of 0 degree centigrade or less, the marshmallows in the invention do not get hard and keeps their pleasant texture. An ice cream is a typical frozen dessert matrix with which the marshmallows are mixed. At this time, the ice cream to be used preferably has an overrun (OR) in a range of 40 to 200% and more preferably in a range of 70 to 150%, because the marshmallows in the present invention are apt to get slightly hard when the marshmallows are mixed with an ice cream having an OR of less than 40%.

A preferred size range of the marshmallow for manufacturing a frozen dessert is wider than the preferred size range of the marshmallows for topping a beverage described above. More specifically, as described above, the marshmallows for topping a beverage is a disk shape that has preferably, for example, a diameter in a range of 10 to 20 mm, a central part thickness in a range of 4 to 10 mm, and a ratio of the diameter to the central part thickness in a range of 1.0 to 5.0, while the marshmallows to be mixed with a frozen dessert matrix may be of a similar shape having, for example, a homothetic ratio in a range of 0.5 to 1.5.

Now, preferred embodiments of the present invention are described in detail below, though the invention is not limited thereto.

### Embodiment 1

1. Manufacturing of Marshmallows

First, 2.3 kg of gelatin was dissolved in 7 kg of water to prepare a gelatin solution, which was set aside until next process. In the meantime, 10 kg of water, 30 kg of sucrose, 15 kg of starch syrup saccarized by reduction, and 13 kg of starch syrup saccarized by enzyme were put into a heating kneader and blended under 2.5 MPa of vapor pressure at a temperature of 106 degrees centigrade for 35 to 40 minutes. The mixed solution was transferred into a stainless-steel blender and softly stirred at 15 rpm keeping the blender at a temperature of 65 degrees centigrade. The temperature of the mixed solution decreased to a temperature of 80 degrees centigrade in one or two minutes, and then all of the gelatin solution set aside was added into the blender. Then, the number of rotations of the blender was run up to 45 rpm, aeration of the mixed solution of the sugars and the gelatin was commenced, and the mixed solution was stirred and beaten for approximately 35 minutes. When concentration of the mixed solution was found to be 420 g/L by sampling it on the way of beating, 0.25 kg of vanilla flavoring was put thereinto and the stirring and beating of the mixed solution was continued for a while. Then, when the temperature of the mixed solution became 53±1 degrees centigrade by lowering the temperature of the blender, the mixed solution was transferred into a filler. Corn starch was sprinkled on trays each having shallow hemispheroidal depressions. While the trays were conveyed by a conveyor, the mixed solution was filled in each of the depressions from above. The marshmallows are completed by solidifying the mixed solution by letting the solution stand at cool room temperature.

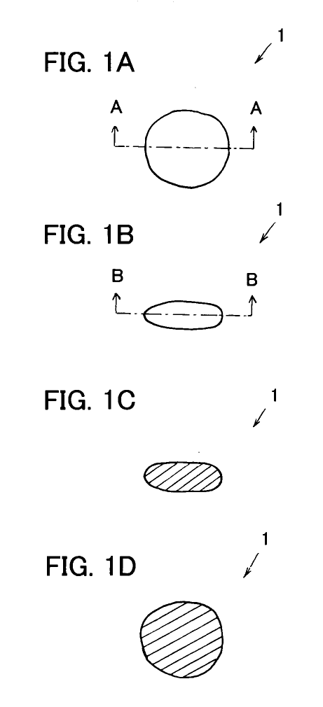

FIGS. 1A to 1D jointly show a marshmallow 1 in the preferred embodiment of the present invention. More specifically, FIG. 1A is a plan view, FIG. 1B is a front view, FIG. 1C is a cross-sectional view taken along line A-A of FIG. 1A, and FIG. 1D is a cross-sectional view taken along line B-B of FIG. 1B. As shown in FIGS. 1A, 1B, 1C, and 1D, the marshmallow 1 is of a disk shape that has a substantially circular periphery in a plan view and has curved outlines at the periphery. The marshmallow 1 may otherwise be described as being of a disk shape that has a substantially circular periphery in a plan view and is tapered to decrease its thickness toward its periphery.

Further, the marshmallow 1 has a substantially horizontal or slightly tapered outline from its central part toward the peripheral part. In other words, the marshmallow 1 has the shape like a “Go” piece (for Japanese “Go” game) or a flat marble. The marshmallow 1 has a diameter in a range of 17 to 18 mm and a thickness in a range of 6 to 7 mm at its central part. The marshmallow 1 preferably has a diameter in a range of 10 to 20 mm, and more preferably a diameter in a range of 17 to 18 mm as described above. The marshmallow 1 preferably has a thickness in a range of 4 to 10 mm at its central part, and more preferably a thickness in a range of 6 to 7 mm as described above.

The marshmallow 1 preferably has a weight in a range of 0.4 to 1.2 g per one piece, and more preferably a weight in a range of 0.5 to 0.8 g.

The marshmallow 1 has a higher elasticity and a higher moisture than the conventional one.

2. Property of Marshmallows

A water activity of the marshmallow 1 in the preferred embodiment was measured with the use of the water activity measurement system Aw-CCP type (rotronic HYGROMER A2) manufactured by Rotronic Instrument Corp. Ten of the marshmallows 1 were picked at random for measurement. Each of the ten marshmallows 1 was cut into quarters, two segments of which were provided as samples for measurement. As a result of the measurement, its water activity was within the range from 0.70 to 0.75. On the other hand, as a result of the measurement of a water activity of the conventional ones available in the market in a similar way, its water activity in either one was 0.67 or below, meaning that the marshmallows 1 in the preferred embodiment had a higher water activity. The marshmallows 1 were similar to the conventional ones in water content. Other ingredient values of the marshmallow 1 were as follows: 292 kcal, 17 to 20% water, 3.0% by weight protein, 0.5% by weight lipid, and 76.3% by weight carbohydrate.

### Embodiment 2

1. Preparation of Marshmallow Coffee

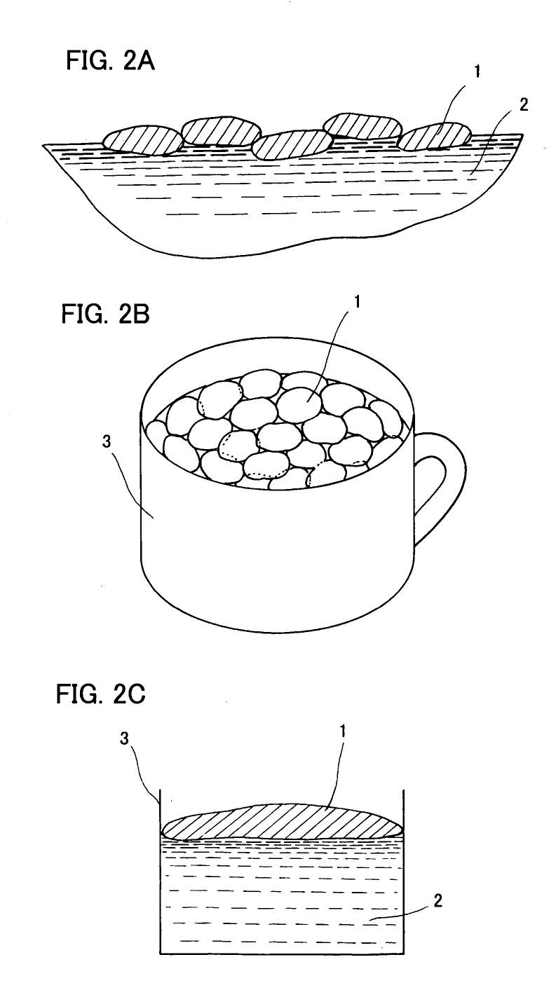

Hot coffee 2 that had just been brewed with boiling water was poured into a coffee cup 3 having a diameter of approximately 80 mm and topped with fifteen marshmallows 1 in the embodiment. This state is shown in FIGS. 2A to 2C. More specifically, as shown in FIGS. 2A and 2B, the marshmallows 1 manufactured in the embodiment 1 covered the whole surface of the coffee 2 substantially uniformly, with slightly overlapping one another, with no space therebetween, and with no excessive overlapping. The marshmallows 1 started to be dissolved by themselves after one or two minutes left at rest until the dissolved marshmallows are fused to form a uniform layer as shown in FIG. 2C, covering the surface of the coffee 2. The layer of the liquefied marshmallows 1 was rich in bubbles, being creamy and smoothly to the taste. Further, a picture of a plurality of marshmallows 1 being liquefied into one was aesthetically pleasant and appetizing.

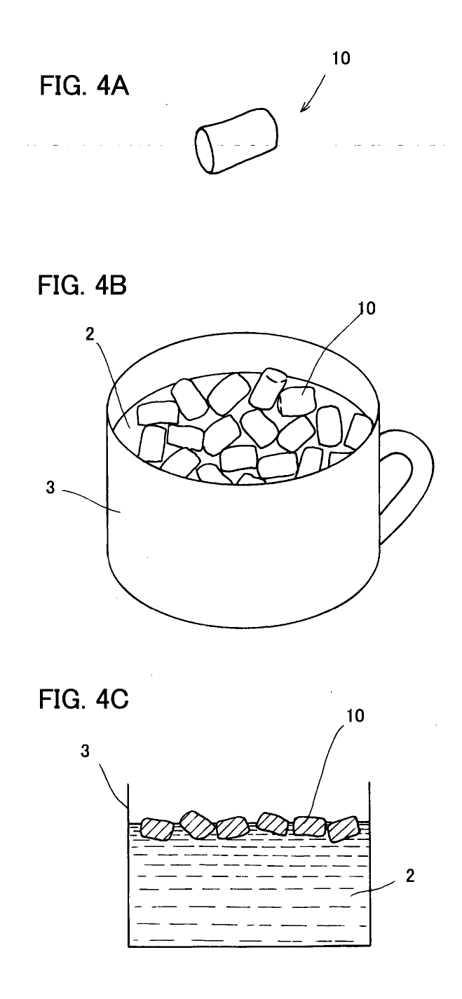

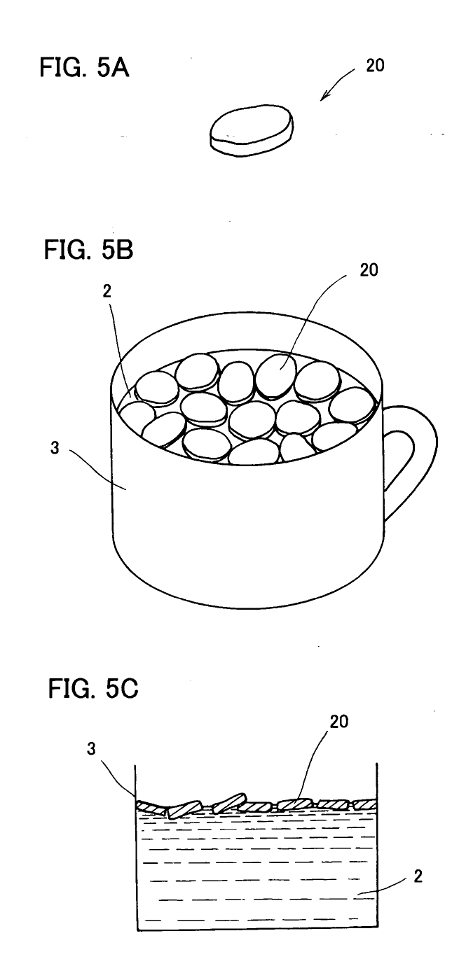

On the other hand, coffees topped with conventional marshmallows were shown in FIGS. 4A to 4C and 5A to 5C. More specifically, the marshmallows 10 shown in FIG. 4A, each of which was of a columnar shape having a diameter of 10 mm and a height or length of 20 mm, and the marshmallows 20 shown in FIG. 5A, each of which was of a flat disk shape with no curved surface at its periphery and having a diameter of 10 mm and a height of 6 mm did not uniformly cover the surface of the coffee 2, as shown in FIGS. 4B, 4C, 5B, and 5C, because the marshmallows 10 and 20 did not have suitable shapes for overlapping and had space therebetween. Further, the marshmallow 10 and 20 left at rest were not dissolved, and started to be dissolved only by being stirred with a spoon, resulting in poorly being dissolved (liquefied) and leaving in soluble mass. Either coffee 2 were nonsmooth to the taste and were aesthetically unappetizing.

### Embodiment 3

1. Preparation of an Ice Cream with Marshmallows

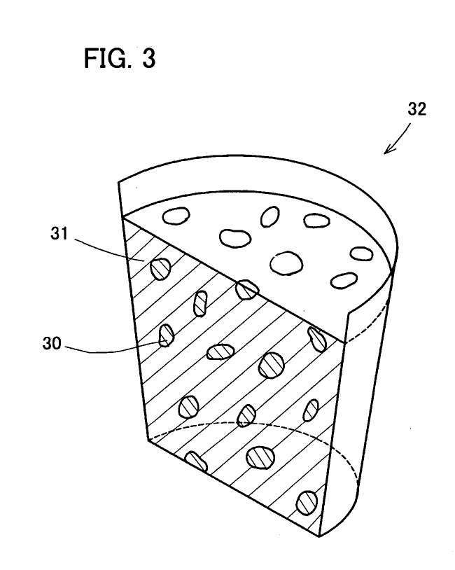

By a common procedure, an ice cream mix was prepared and homogenized by a homogenizer. After being sterilized at a temperature of 68 degrees centigrade for 30 minutes, the homogenized ice cream mix was cooled and stored up for 8 to 24 hours at a temperature in a range of 1 to 5 degrees centigrade. Then, air was supplied into the ice cream mix so that OR (overrun) of the ice cream to be prepared should be about 80%, then marshmallows manufactured by the same procedure as in the embodiment 1 and having a total volume equal to one tenth of the overall volume of the aerated ice cream mix were added to the aerated ice cream mix. After being mixed enough, the aerated ice cream mix containing the marshmallows was frozen partially at a temperature of 4 to 9 degrees centigrade below zero. Herein, small-sized marshmallows having a diameter of about 10 mm were used. Next, the partially frozen ice cream mix containing the marshmallows was filled in a cup and frozen below 20 degrees below zero so as to manufacture an ice cream with marshmallows. As a comparative example, an ice cream with marshmallows was manufactured by the same procedure with the use of an ice cream mix having an OR of 40%. FIG. 3 shows a cross-sectional view showing a frozen dessert 32 (i.e., an ice cream with marshmallows) in the embodiment. Referring to the figure, the frozen dessert 32 in the embodiment has the marshmallows 30 evenly dispersed within an ice cream 31.

The marshmallows 30 contained in the ice cream 31 in the embodiment were soft and tasted good even if they were eaten with the ice cream 31. On the other hand, the marshmallows in the ice cream in the comparative example were rather hard and had a poor texture.

2. Eating-Quality Test

Ten testers ate the ice creams with marshmallows in the embodiment and in the comparative example so as to compare their tastes and their textures. As a result of the test, all the testers judged that the ice cream with marshmallows in the embodiment had a more pleasant texture and tasted better.

1. A marshmallow having a water activity of 0.70 or more.

2. The marshmallow as defined in claim 1, having a water activity of 0.75 or less.

3. The marshmallow as defined in claim 1, being of a disk shape that has a substantially circular periphery in a plan view and has curved outlines at the periphery in a vertical section.

4. The marshmallow as defined in claim 1, being of a disk shape that has a substantially circular periphery in a plan view and is tapered to decrease its thickness toward its periphery.

5. The marshmallow as defined in claim 1, being of a disk shape having a central part thickness larger than a thickness at its peripheral part.

6. The marshmallow as defined in claim 3, having a diameter and a central part thickness with a ratio of the diameter to the central part thickness in a range of 1.0 to 5.0.

7. The marshmallow as defined in claim 3, having a diameter in a range of 10 to 20 mm.

8. The marshmallow as defined in claim 3, having a central part thickness in a range of 4 to 10 mm.

9. The marshmallow as defined in claim 4, having a diameter and a central part thickness with a ratio of the diameter to the central part thickness in a range of 1.0 to 5.0.

10. The marshmallow as defined in claim 4, having a diameter in a range of 10 to 20 mm.

11. The marshmallow as defined in claim 4, having a central part thickness in a range of 4 to 10 mm.

12. The marshmallow as defined in claim 5, having a diameter and a central part thickness with a ratio of the diameter to the central part thickness in a range of 1.0 to 5.0.

13. The marshmallow as defined in claim 5, having a diameter in a range of 10 to 20 mm.

14. The marshmallow as defined in claim 5, having a central part thickness in a range of 4 to 10 mm.

15. A marshmallow formed by pouring a liquid containing at least either of sugar and gelatin and having a density in a range of 400 to 440 g/L into a mold by a filler and solidifying the liquid.

16. The marshmallow as defined in claim 15, having a water activity of 0.70 or more.

17. The marshmallow as defined in claim 15, being of a disk shape that has a substantially circular periphery in a plan view and has curved outlines at the periphery in a vertical section.

18. The marshmallow as defined in claim 15, being of a disk shape that has a substantially circular periphery in a plan view and is tapered to decrease its thickness toward its periphery.

19. The marshmallow as defined in claim 15, being of a disk shape having a central part thickness larger than a thickness at its peripheral part.

20. The marshmallow as defined in claim 17, having a diameter and a central part thickness with a ratio of the diameter to the central part thickness in a range of 1.0 to 5.0.

21. The marshmallow as defined in claim 17, having a diameter in a range of 10 to 20 mm.

22. The marshmallow as defined in claim 17, having a central part thickness in a range of 4 to 10 mm.

23. The marshmallow as defined in claim 18, having a diameter and a central part thickness with a ratio of the diameter to the central part thickness in a range of 1.0 to 5.0.

24. The marshmallow as defined in claim 18, having a diameter in a range of 10 to 20 mm.

25. The marshmallow as defined in claim 18, having a central part thickness in a range of 4 to 10 mm.

26. The marshmallow as defined in claim 19, having a diameter and a central part thickness with a ratio of the diameter to the central part thickness in a range of 1.0 to 5.0.

27. The marshmallow as defined in claim 19, having a diameter in a range of 10 to 20 mm.

28. The marshmallow as defined in claim 19, having a central part thickness in a range of 4 to 10 mm.

29. A marshmallow having a water activity in a range of 0.70 to 0.75 and being of a disk shape that has:
a substantially circular periphery in a plan view;
curved outlines at the periphery in a vertical section;
a diameter in a range of 10 to 20 mm;
a central part thickness in a range of 4 to 10 mm; and
a ratio of the diameter to the central part thickness in a range of 1.0 to 5.0.

30. The marshmallow as defined in claim 29, formed by pouring a liquid containing at least either of sugar and gelatin and having a density in a range of 400 to 440 g/L into a mold by a filler and solidifying the liquid.

31. A beverage topped with marshmallows,
wherein the marshmallows as defined in claim 1 are dissolved while topping the surface of the beverage that has a temperature of 40 degrees centigrade or more.

32. The beverage as defined in claim 31,
wherein the beverage is one selected from a group consisting of coffee, cocoa, powdered green tea, black tea, Japanese tea, oolong tea, and milk.

33. A beverage topped with marshmallows,
wherein the marshmallows as defined in claim 3 are dissolved while topping the surface of the beverage that has a temperature of 40 degrees centigrade or more.

34. The beverage as defined in claim 33,
wherein the beverage is one selected from a group consisting of coffee, cocoa, powdered green tea, black tea, Japanese tea, oolong tea, and milk.

35. A frozen dessert formed by mixing the marshmallows as defined in claim 1 with a frozen dessert matrix.

36. The frozen dessert as defined in claim 35, the matrix being an ice cream.

37. The frozen dessert as defined in claim 36, having an overrun in a range of 40 to 200%.

38. A frozen dessert formed by mixing the marshmallows as defined in claim 3 with a frozen dessert matrix.

39. The frozen dessert as defined in claim 38, the matrix being an ice cream.

40. The frozen dessert as defined in claim 39, having an overrun in a range of 40 to 200%.
